(19) United States
(12) Patent Application Publication
(10) Pub. No.: US 2016/0314902 A1
(43) Pub. Date: Oct. 27, 2016

(54) MULTILAYER CERAMIC CAPACITOR AND METHOD OF MANUFACTURING THE SAME

(71) Applicant: SAMSUNG ELECTRO-MECHANICS CO., LTD., Suwon-si (KR)

(72) Inventors: Kyoung No LEE, Suwon-si (KR); Hyun Hee GU, Suwon-si (KR); Kyu Ha LEE, Suwon-si (KR); Jun Hyeong KIM, Suwon-si (KR); Eun Joo CHOI, Suwon-si (KR)

(21) Appl. No.: 14/995,089

(22) Filed: Jan. 13, 2016

(30) Foreign Application Priority Data
Apr. 21, 2015 (KR) 10-2015-0055879

(51) Int. Cl. H01G 4/248; H01G 4/232; H01G 4/008; H01G 4/30; H01G 4/12

(52) U.S. Cl. CPC H01G 4/248; H01G 4/30; H01G 4/12; H01G 4/008; H01G 4/2325

(57) ABSTRACT

A multilayer ceramic capacitor includes a ceramic body including a plurality of dielectric layers and first and second internal electrodes; and first and second external electrodes connected to the first and second internal electrodes, respectively. The first and second external electrodes include: first and second connection layers including the same first conductive material as the first and second internal electrodes and formed on opposite surfaces of the ceramic body to be connected to the first and second internal electrodes, respectively; and first and second terminal layers including a second conductive material different from the first conductive material and formed on the opposite surfaces of the ceramic body to cover the first and second connection layers.

### CROSS-REFERENCE TO RELATED APPLICATION

This application claims benefit of priority to Korean Patent Application No. 10-2015-0055879 filed on Apr. 21, 2015, with the Korean Intellectual Property Office, the disclosure of which is incorporated herein by reference.

### TECHNICAL FIELD

The present disclosure relates to a multilayer ceramic capacitor and a method of manufacturing the same.

### BACKGROUND

Capacitors, inductors, piezoelectric elements, varistors, thermistors, and the like, in electronic components all use ceramic material.

Among ceramic electronic components, a multilayer ceramic capacitor (MLCC) may be used in various electronic devices due to advantages such as compact size, high capacitance, and ease of mounting.

For example, a multilayer ceramic capacitor may be used as a chip-shaped condenser mounted on substrates of various electronic products such as display devices such as liquid crystal displays (LCDs), plasma display panels (PDPs), and the like, computers, personal digital assistants (PDAs), and mobile phones to charge or discharge electricity.

A multilayer ceramic capacitor includes a ceramic body and external electrodes. The ceramic body is manufactured by alternately stacking and pressing a plurality of dielectric layers and internal electrodes receiving different polarities between the dielectric layers, followed by plasticizing and sintering, and external electrodes are formed by applying a conductive paste on the sintered ceramic body.

In accordance with the recent trend toward miniaturization and high speed of electronic products, a multilayer ceramic capacitor has been also required to be compact and have a large degree of capacitance.

Accordingly, in order for a multilayer ceramic capacitor having the same size as conventional multilayer ceramic capacitors implements to have higher capacitance, dielectrics are required to be formed of high-k ceramic materials and to be stacked in higher numbers.

However, since the size of a multilayer ceramic capacitor is limited, thickness of dielectric layers is required to be as thin as possible. In a case in which the dielectric layers are thin, when internal electrodes formed of nickel and external electrodes formed of copper are used, and the external electrodes are sintered, copper components of the external electrodes are diffused toward nickel components of the internal electrodes, volume of the internal electrodes is expanded. To relive stress caused by the volume expansion, cracks occur in the ceramic body, thereby lowing reliability of the capacitor.

### SUMMARY

An aspect of the present disclosure may provide a multilayer ceramic capacitor capable of preventing the occurrence of cracks in a ceramic body even when a thickness of dielectric layers is reduced, and a method of manufacturing the same.

According to an aspect of the present disclosure, a multilayer ceramic capacitor may include: a ceramic body including a plurality of dielectric layers and first and second internal electrodes; and first and second external electrodes connected to the first and second internal electrodes, respectively. The first and second external electrodes include: first and second connection layers including the same first conductive material as the first and second internal electrodes and formed on opposite surfaces of the ceramic body to be connected to the first and second internal electrodes, respectively; and first and second terminal layers including a second conductive material different from the first conductive material and formed on the opposite surfaces of the ceramic body to cover the first and second connection layers, respectively.

According to another aspect of the present disclosure, a method of manufacturing a multilayer ceramic capacitor may include: preparing a laminate by forming first and second internal electrodes on a plurality of ceramic sheets using a conductive paste including nickel, and stacking and pressing the plurality of ceramic sheets so that the first and second internal electrodes face each other; preparing a ceramic body by cutting the laminate into each region corresponding to one capacitor, followed by sintering; and forming first and second external electrodes on the ceramic body to be connected to the first and second internal electrodes, respectively. The forming of the first and second external electrodes includes: forming first and second connection layers by applying a conductive paste including nickel or a nickel alloy and glass on opposite surfaces of the ceramic body in a length direction; and forming first and second terminal layers by applying a conductive paste or a conductive epoxy resin including copper and glass on the opposite surfaces of the ceramic body in the length direction so as to cover the first and second connection layers, respectively.

### BRIEF DESCRIPTION OF DRAWINGS

The above and other aspects, features, and advantages of the present disclosure will be more clearly understood from the following detailed description taken in conjunction with the accompanying drawings, in which:

FIG. 1 is a perspective view schematically illustrating a multilayer ceramic capacitor according to an exemplary embodiment in the present disclosure;

FIG. 2 is an exploded perspective view schematically illustrating a structure of internal electrodes of the multilayer ceramic capacitor according to an exemplary embodiment in the present disclosure; and

FIG. 3 is a cross-sectional view taken along line A-A′ of FIG. 1.

### DETAILED DESCRIPTION

Hereinafter, embodiments of the present disclosure will be described in detail with reference to the accompanying drawings.

The disclosure may, however, be embodied in many different forms and should not be construed as being limited to the embodiments set forth herein. Rather, these embodiments are provided so that this disclosure will be thorough and complete, and will fully convey the scope of the disclosure to those skilled in the art.

In the drawings, the shapes and dimensions of elements maybe exaggerated for clarity, and the same reference numerals will be used throughout to designate the same or like elements.

Multilayer Ceramic Capacitor

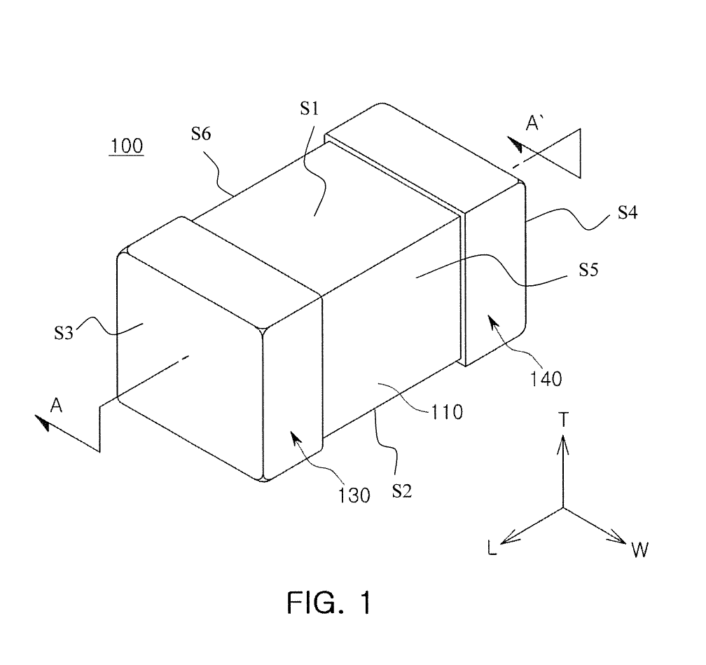

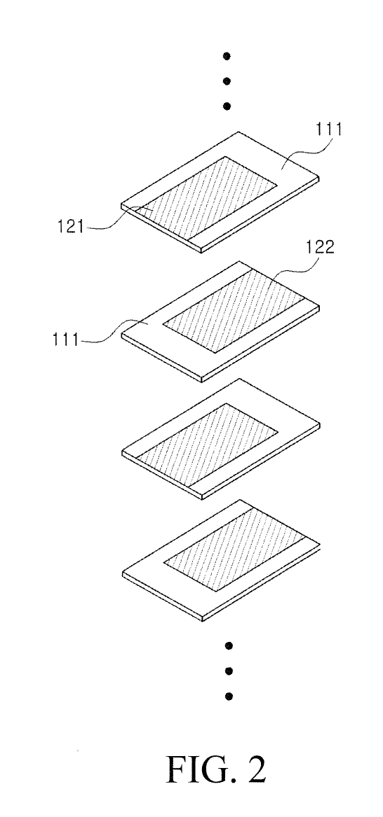

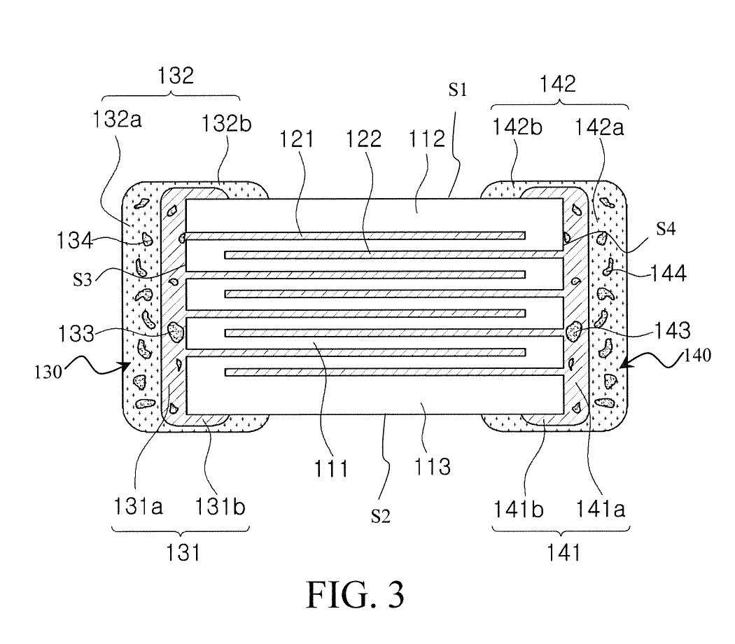

FIG. 1 is a perspective view schematically illustrating a multilayer ceramic capacitor according to an exemplary embodiment, FIG. 2 is an exploded perspective view schematically illustrating a structure of internal electrodes of the multilayer ceramic capacitor according to an exemplary embodiment, and FIG. 3 is a cross-sectional view taken along line A-A′ of FIG. 1.

Referring to FIGS. 1 and 2, a multilayer ceramic capacitor 100 according to an exemplary embodiment may include a ceramic body 110, and first and second external electrodes 130 and 140.

Here, the ceramic body 110 may include a plurality of dielectric layers 111 and first and second internal electrodes 121 and 122.

Directions of the ceramic body 110 will be defined in order to clearly describe the exemplary embodiment. Each of L, W, and T illustrated in the accompanying drawings refers to a length direction, a width direction, and a thickness direction, respectively. Here, the thickness direction may be used with the same meaning as a direction in which the dielectric layers 111 are stacked.

The ceramic body 110 may be formed by stacking the plurality of dielectric layers 111 in the thickness direction T, followed by sintering. In this case, a shape and a dimension of the ceramic body 110 and the number of stacked dielectric layers 111 are not limited to those of the present exemplary embodiment illustrated in the accompanying drawings.

Here, the plurality of dielectric layers 111 forming the ceramic body 110 may be in a sintered state, and may be integrated so as to be difficult to confirm a boundary between the dielectric layers 111 adjacent to each other without using a scanning electron microscope (SEM).

In addition, the ceramic body 110 is not specifically limited in view of a shape, and for example, may have a hexahedral shape.

In the present exemplary embodiment, for convenience of explanation, surfaces opposing each other in the thickness direction T in which the dielectric layers 111 of the ceramic body 110 are stacked refer to first and second surfaces S1 and S2, surfaces connecting the first and second surfaces S1 and S2 to each other and opposing each other in the length direction L refer to third and fourth surfaces S3 and S4, and surfaces vertically crossing the third and fourth surfaces and opposing each other in the width direction W refer to fifth and sixth surfaces S5 and S6.

Further, as shown in FIG. 3, the ceramic body 110 may have an upper cover layer 112 formed above a first internal electrode 121 of an uppermost part and a lower cover layer 113 formed below a second internal electrode 122 of a lowermost part, wherein the upper cover layer 112 has a predetermined thickness.

For example, the upper cover layer 112 and the lower cover layer 113 may be formed of the same composition as that of the dielectric layer 111, and may be formed by stacking at least one dielectric layer 111 above the first internal electrode of the uppermost part and below the second internal electrode of the lowermost part of the ceramic body 110, respectively, wherein the dielectric layer 111 does not include the internal electrodes.

The dielectric layer 111 may include a high-k ceramic material, such as a barium titanate (BaTiO₃) based ceramic powder. However, the high-k ceramic material is not limited thereto.

Examples of the BaTiO₃-based ceramic powder may include (Ba₁₋ₓCaₓ)TiO₃, Ba(Ti_{1-y}Ca_{y})O₃, (Ba₁₋ₓCaₓ)(Ti_{1-y}Zr_{y})O₃, Ba(Ti_{1-y}Zr_{y})O₃, and the like, in which Ca, Zr, or the like, is partially dissolved in BaTiO₃. However, the BaTiO₃-based ceramic powder is not limited thereto.

In addition, the dielectric layer 111 may further include at least one ceramic additive, organic solvent, plasticizer, binder, and dispersant, if needed.

As the ceramic additive, a transition metal oxide or carbide, a rare earth element, magnesium (Mg), aluminum (Al), or the like, may be used.

The first and second internal electrodes 121 and 122 may be formed on ceramic sheets forming the dielectric layers 111 and stacked in the thickness direction T, and then sintered, and thus the first and second internal electrodes 121 and 122 are alternately disposed in the ceramic body 110 in the thickness direction T with one of the dielectric layers 111 interposed therebetween.

The first and second internal electrodes 121 and 122, which are a pair of electrodes having different polarities, may be disposed to face each other in a direction in which the dielectric layers 111 are stacked, and may be electrically insulated from each other by the dielectric layers 111 disposed therebetween.

One end of each of the first and second internal electrodes 121 and 122 may be exposed through each of the third and fourth surfaces S3 and S4 of the ceramic body 110 in the length direction L.

In addition, end portions of the first and second internal electrodes 121 and 122 exposed through the third and fourth surfaces S3 and S4 of the ceramic body 110 in the length direction L may be electrically connected to the first and second external electrodes 130 and 140, respectively, at the third and fourth surfaces S3 and S4 of the ceramic body 110 in the length direction L.

Each thickness of the first and second internal electrodes 121 and 122 may be determined according to the use thereof. For example, when considering the size of the ceramic body 110, the thickness may be determined to be within a range of 0.05 μm to 2.5 μm. However, the thickness of the first and second internal electrodes is not limited thereto.

Here, the first and second internal electrodes 121 and 122 may be formed of a conductive metal, such as nickel (Ni), a nickel (Ni) alloy, or the like, in the present exemplary embodiment. However, the conductive metal forming the first and second internal electrodes is not limited thereto.

A method of printing the conductive metal may include a screen printing method, a gravure printing method, or the like, but the method of printing the conductive metal is not limited thereto.

According to the above-described configuration, when a predetermined voltage is applied to the first and second external electrodes 130 and 140, electric charges are accumulated between the first and second internal electrodes 121 and 122 opposing each other. Here, capacitance of the multilayer ceramic capacitor 100 is in proportion to an area in which the first and second internal electrodes 121 and 122 overlap each other in the direction in which the dielectric layers 111 are stacked.

Referring to FIG. 3, the first and second external electrodes 130 and 140 may be formed on the third and fourth surfaces S3 and S4 of the ceramic body 110 in the length direction L, and may contact and may be electrically connected to exposed portions of the first and second internal electrodes 121 and 122, respectively.

The first and second external electrodes 130 and 140 may have a bi-layer structure, and may include first and second connection layers 131 and 141 formed on the third and fourth surfaces S3 and S4 of the ceramic body 110 to directly contact the exposed portions of the first and second internal electrodes 121 and 122, respectively, and first and second terminal layers 132 and 142 formed on the third and four surfaces S3 and S4 of the ceramic body 110 in the length direction L to cover the first and second connection layers 131 and 141, respectively.

The first and second connection layers 131 and 141 may be formed of a conductive paste including the metal component which is the same conductive material as the first and second internal electrodes 121 and 122 to be connected to the first and second connection layers, and glass. The conductive paste may include nickel (Ni) or the nickel alloy which is the same as the first and second internal electrodes 121 and 122 as the conductive metal, and glass 133 and 143.

Here, the glass 133 and 143 serve as an adhesive between the ceramic body 110 and the first and second connection layers 131 and 141.

When conventional internal electrodes formed of nickel and conventional external electrodes formed of copper are used, volume expansion of the internal electrodes may occur by diffusing copper components of the external electrodes toward nickel components of the internal electrodes when the external electrodes are sintered.

However, in the present exemplary embodiment, since the first and second connection layers 131 and 141 are formed of the same kinds of metal component as the first and second internal electrodes 121 and 122, the volume expansion of the internal electrodes may be prevented to minimize an occurrence of stress, thereby effectively preventing cracks in the ceramic body 110.

In addition, when the external electrodes of the conventional multilayer ceramic capacitor are formed on the ceramic body, problems such as deterioration of capacitance, and the like, due to a reduction of contact ability, may occur. However, the first and second connection layers 131 and 141 may include the same metal component as the first and second internal electrodes 121 and 122 in the present exemplary embodiment, and thus connectivity between the internal electrodes and the external electrodes may be improved, thereby preventing problems such as deterioration of capacitance, and the like.

Meanwhile, the first and second connection layers 131 and 141 may include first and second connection body parts 131a and 141a formed on the third and fourth surfaces S3 and S4 of the ceramic body 110 in the length direction L and first and second connection band parts 131b and 141b extending from the first and second connection body parts 131a and 141a up to portions of the first and second surfaces S1 and S2 of the ceramic body 110 in the thickness direction T and portions of the fifth and sixth surfaces S5 and S6 of the ceramic body 110 in the width direction W.

When the connection layers have the connection band parts as described above, adhesion strength to the ceramic body 110 may be improved.

The first and second terminal layers 132 and 142 may include a conductive material different from the first and second connection layers 131 and 141, and, for example, may be formed of a conductive paste, a conductive epoxy paste, and the like, including powder containing copper and glass 134 and 144.

In addition, the glass 134 and 144 may serve as an adhesive between the ceramic body 110 and the first and second terminal layers 132 and 142, and may function to increase hermetic sealing properties by filling empty space in which the sintered copper components are not provided.

The first and second connection layers 131 and 141 may lack hermetic sealing due to the characteristics of nickel. Here, the lack of hermetic sealing requires a high-temperature environment when the connection layers are formed in order to achieve densification, since the sintering temperature of nickel is higher than that of copper, and in this case, the sealing may be performed with nickel only. In the present exemplary embodiment, the first and second terminal layers 132 and 142 may be formed of copper or epoxy to strengthen hermetic sealing properties even at a relatively low temperature, thereby improving moisture resistance, and thus much higher reliability may be implemented when the capacitor is mounted on a substrate. Accordingly, an effect in which plating layers for sealing are not required to be separately formed may be provided.

In addition, according to recent trends, a thickness of the dielectric layer becomes reduced, for example, 2.0 μm or less, or more reduced at 1.5 μm or less, for implementing the capacitor having a compact size and high capacitance. However, in this case, radiation cracks may occur in the capacitor. Since mechanical properties of the external electrodes are significantly improved due to structural differences between the terminal layers and the connection layers in the present exemplary embodiment, even though the thickness of the dielectric layer is reduced to be 2.0 μm or less, or more reduced at 1.5 μm or less as described above, the occurrence of cracks in the ceramic body may be effectively prevented.

For example, when the external electrodes were formed of only copper components, a high temperature accelerated lifetime pass rate was 60%, a moisture resistance reliability pass rate was 56%, and a radiation crack pass rate was 30%. When the external electrodes were formed of only nickel components, the radiation crack pass rate was improved to 100%, but the high temperature accelerated lifetime pass rate was reduced to 55%, and the moisture resistance reliability pass rate was reduced to 48%.

However, when the external electrodes have a bi-layer structure, and the connection layers of an inner side are formed of nickel and the terminal layers of an outer side are formed of copper according to the present exemplary embodiment, it could be appreciated that the high temperature accelerated lifetime pass rate was 60%, and the moisture resistance reliability pass rate was 63%, which were similar to each other or higher than those of the external electrodes formed of only copper components, and the radiation crack pass rate was 100%, and thus cracks could also be effectively prevented.

In addition, as another example, when the external electrodes have a bi-layer structure and the connection layers of an inner side are formed of nickel and the terminal layers of the outer side are formed in a soft term manner, it could be appreciated that the high temperature accelerated lifetime pass rate and the moisture resistance reliability pass rate were largely improved to be 90% and 80%, respectively, and the radiation crack pass rate was 100%, and thus cracks could also be effectively prevented.

Meanwhile, the first and second terminal layers 132 and 142 may include first and second terminal body parts 132a and 142a formed on the third and fourth surfaces S3 and S4 of the ceramic body 110 in the length direction L to cover the first and second connection body parts 131a and 141a and the first and second terminal band parts 132b and 142b extending from the first and second connection body parts 132a and 142a up to the portions of the first and second surfaces S1 and S2 of the ceramic body 110 in the thickness direction T and portions of the fifth and sixth surfaces S5 and S6 of the ceramic body 110 in the width direction W to cover the first and second connection band parts 131b and 141b.

When the terminal layers have the terminal band parts as described above, adhesion strength to the ceramic body 110 may be improved.

Method of Manufacturing a Multilayer Ceramic Capacitor

Hereinafter, a method of manufacturing the multilayer ceramic capacitor according to an exemplary embodiment will be described.

First, a plurality of ceramic sheets may be prepared.

For forming the dielectric layers 111 of the ceramic body 110, the ceramic sheets may be produced by mixing ceramic powder, a polymer, a solvent, and the like, to prepare a slurry, and then applying and drying the slurry on a carrier film using a doctor blade method, or the like, to be in a sheet shape having a thickness of several micrometers (μm)

Then, first and second internal electrodes 121 and 122 may be formed by printing a conductive paste including nickel on at least one surface of each of the plurality of ceramic sheets so as to have a predetermined thickness.

Here, the first and second internal electrodes 121 and 122 may be exposed through opposite end surfaces of the ceramic sheet in the length direction L, respectively.

In addition, as a method of printing the conductive paste, a screen printing method, a gravure printing method, or the like, may be used. However, the method of printing the conductive paste is not limited thereto.

Next, a laminate may be prepared by stacking and pressing the plurality of ceramic sheets on which the first and second internal electrodes 121 and 122 are formed so that the first and second internal electrodes 121 and 122 face each other with each of the ceramic sheets interposed therebetween.

Here, the laminate may be prepared by stacking and pressing the plurality of ceramic sheets in a thickness direction T.

Next, a ceramic body 110 may be prepared by cutting the laminate into each region corresponding to one capacitor, followed by sintering at a high temperature, wherein the ceramic body has first and second surfaces S1 and S2 opposing each other in the thickness direction T, third and fourth surfaces S3 and S4 in the length direction L in which the first and second internal electrodes 121 and 122 are alternately exposed, and fifth and sixth surfaces S5 and S6 in a width direction W.

In the present exemplary embodiment, since the ceramic body 110 is prepared by sintering the laminate in which the external electrodes are not formed, residual carbon of the ceramic body 110 may be reduced.

Then, first and second external electrodes 130 and 140 maybe formed on the third and fourth surfaces S3 and S4 of the ceramic body 110 so as to be electrically connected to portions in which the first and second internal electrodes 121 and 122 are exposed, respectively.

Hereinafter, a method of forming the first and second external electrodes according to an exemplary embodiment will be specifically described.

First, first and second connection layers 131 and 141 maybe respectively formed on the third and fourth surfaces S3 and S4 of the ceramic body 110 by applying a conductive paste including nickel-glass powder or nickel-alloy-glass powder the same as powders included in the internal electrodes, so as to cover the first and second internal electrodes 121 and 122 exposed through the third and fourth surfaces S3 and S4 of the ceramic body 110.

In the present exemplary embodiment, after the ceramic body is prepared by sintering the laminate, the external electrodes maybe formed. When the first and second connection layers 131 and 141 including nickel are primarily formed in the ceramic body 110, followed by sintering, it is difficult to remove a binder, and the like, included in the ceramic body 110, and thus it may be difficult to determine sintering conditions. In addition, since the conductive paste for the external electrodes is applied by using a green multilayer ceramic capacitor, in a case in which power is applied in a state in which strength, and the like, of the ceramic body 110 are not secured when the conductive paste is applied, in a case in which the multilayer ceramic capacitor contacts a surface plate when dipped, deformation may occur in the multilayer ceramic capacitor itself.

Here, the first and second connection layers 131 and 141 may include first and second connection body parts 131a and 141a formed by applying the conductive paste on the first and second surfaces S1 and S2 of the ceramic body 110 and first and second connection band parts 131b and 141b extending from the first and second connection body parts 131a and 141a by further applying the conductive paste on portions of the first and second surfaces S1 and S2 of the ceramic body 110 in the thickness direction T and portions of the fifth and sixth surfaces S5 and S6 of the ceramic body in the width direction W.

Here, a method of applying the conductive paste may be, for example, a dipping method, but the method of applying the conductive paste is not limited thereto.

In addition, after the first and second connection layers 131 and 141 are formed in the ceramic body 110, the applied conductive paste may be solidified by performing a heat treatment.

Next, first and second terminal layers 132 and 142 may be formed by applying a conductive paste or a conductive epoxy resin including copper-glass powder on the third and fourth surfaces S3 and S4 of the ceramic body 110 so as to cover the first and second connection layers 131 and 141.

Here, the first and second terminal layers 132 and 142 may include first and second terminal body parts 132a and 142a formed by applying the conductive paste or a conductive epoxy resin on the first and second connection body parts 131a and 141a, and first and second terminal band parts 132b and 142b extending from the first and second terminal body parts 132a and 142a by further applying the conductive paste or the conductive epoxy resin on the portions of the first and second surfaces S1 and S2 of the ceramic body 110 in the thickness direction T and the portions of the fifth and sixth surfaces S5 and S6 of the ceramic body 110 in the width direction W to cover the first and second connection band parts 131b and 141b.

Here, a method of applying the conductive paste may be, for example, a dipping method, or a method of using a roller as another example thereof, or the like, and thus the method of applying the conductive paste is not limited thereto.

For example, when the first and second terminal layers 132 and 142 are formed of the conductive epoxy resin, primarily, the first and second connection layers 131 and 141 may be formed in a head stroke manner, and the first and second terminal layers 132 and 142 may be formed in a soft term manner. In this case, mechanical properties and stress applied to the multilayer ceramic capacitor the multilayer ceramic capacitor is mounted on a substrate are significantly reduced, and thus product reliability may be improved.

As set forth above, according to exemplary embodiments, the multilayer ceramic capacitor has a structure in which the connection layers contacting the internal electrodes in the external electrodes have the same metal component as the internal electrodes, thereby having components different from the conventional internal electrodes and external electrodes, and thus the occurrence of cracks caused by diffusion of the components of the external electrodes toward the components of the internal electrodes may be prevented. Further, the terminal layers toward the outside in the external electrodes may be formed of components having excellent hermetic sealing, thereby improving reliability when the capacitor is mounted on a substrate, and the like.

While exemplary embodiments have been shown and described above, it will be apparent to those skilled in the art that modifications and variations could be made without departing from the scope of the present disclosure as defined by the appended claims.

What is claimed is:

1. A multilayer ceramic capacitor comprising:
a ceramic body including a plurality of dielectric layers and first and second internal electrodes; and
first and second external electrodes connected to the first and second internal electrodes, respectively,
wherein the first and second external electrodes include:
first and second connection layers including the same first conductive material as the first and second internal electrodes and formed on opposite surfaces of the ceramic body to be connected to the first and second internal electrodes, respectively; and
first and second terminal layers including a second conductive material different from the first conductive material and formed on the opposite surfaces of the ceramic body to cover the first and second connection layers, respectively.

2. The multilayer ceramic capacitor of claim 1, wherein the first conducive material is nickel or an nickel alloy,
the first and second internal electrodes are formed of a conductive paste including nickel or a nickel alloy, and
the first and second connection layers are formed of a conductive paste including nickel or the nickel alloy and glass.

3. The multilayer ceramic capacitor of claim 1, wherein the second conducive material is copper, and
the first and second terminal layers are formed of a conductive paste including copper and glass.

4. The multilayer ceramic capacitor of claim 1, wherein the first and second terminal layers are formed of a conductive epoxy resin.

5. The multilayer ceramic capacitor of claim 1, wherein the first and second internal electrodes are alternately stacked so as to be exposed through the opposite surfaces of the ceramic body in a length direction, respectively, with the dielectric layers interposed therebetween, and
the first and second external electrodes are disposed on the opposite surfaces of the ceramic body in the length direction, respectively.

6. The multilayer ceramic capacitor of claim 5, wherein the first and second connection layers extend from the opposite surfaces of the ceramic body in the length direction up to portions of the opposite surfaces of the ceramic body in the thickness direction and portions of the opposite surfaces of the ceramic body in the width direction, respectively.

7. The multilayer ceramic capacitor of claim 1, wherein the first and second connection layers contain no conductive material contained in the first and second terminal layers, and the first and second terminal layers contain no conductive material contained in the first and second connection layers.

8. The multilayer ceramic capacitor of claim 1, wherein the first and second connection layers contain no other conductive material not contained in the first and second internal electrodes.

9. A method of manufacturing a multilayer ceramic capacitor, comprising:
preparing a laminate by forming first and second internal electrodes on a plurality of ceramic sheets using a conductive paste including nickel, and stacking and pressing the plurality of ceramic sheets so that the first and second internal electrodes face each other;
preparing a ceramic body by cutting the laminate into each region corresponding to one capacitor, followed by sintering; and
forming first and second external electrodes on the ceramic body to be connected to the first and second internal electrodes, respectively,
wherein the forming of the first and second external electrodes includes:
forming first and second connection layers by applying a conductive paste including nickel or a nickel alloy and glass on opposite surfaces of the ceramic body in a length direction; and
forming first and second terminal layers by applying a conductive paste or a conductive epoxy resin including copper and glass on the opposite surfaces of the ceramic body in the length direction so as to cover the first and second connection layers, respectively.

10. method of claim 9, wherein the first and second connection layers are formed by dipping the ceramic body in the conductive paste.

11. The method of claim 9, wherein the first and second connection layers are formed by further applying the conductive paste on portions of opposite surfaces of the ceramic body in a thickness direction and opposite surfaces of the ceramic body in a width direction.

12. The method of claim 11, wherein the first and second terminal layers are formed by further applying the conductive paste or the conductive epoxy resin on portions of the opposite surfaces of the ceramic body in the thickness direction and the opposite surfaces of the ceramic body in the width direction so as to cover the first and second connection layers.

13. The method of claim 9, wherein the first and second connection layers contain no conductive material contained in the first and second terminal layers, and the first and second terminal layers contain no conductive material contained in the first and second connection layers.

14. The method of claim 9, wherein the first and second connection layers contain no other conductive material not contained in the first and second internal electrodes.
